(19) United States
(12) Patent Application Publication
(10) Pub. No.: US 2011/0103395 A1
(43) Pub. Date: May 5, 2011

(54) COMPUTING THE BURST SIZE FOR A HIGH SPEED PACKET DATA NETWORKS WITH MULTIPLE QUEUES

(75) Inventors: Niranjan N. Ratnakar, Hillsborough, NJ (US); Ritesh K. Madan, Jersey City, NJ (US); Sundeep Rangan, Jersey City, NJ (US)

(73) Assignee: QUALCOMM INCORPORATED, San Diego, CA (US)

(21) Appl. No.: 12/611,778

(22) Filed: Nov. 3, 2009

(51) Int. Cl. H04L 12/56

(52) U.S. Cl. 370/412

(57) ABSTRACT

A communications method is provided. The method includes processing multiple packet queues for a high speed packet data network and associating one or more arrays for the multiple packet queues. The method also includes generating an index for the arrays, where the index is associated with a time stamp in order to determine a burst size for the high speed packet data network.

### BACKGROUND

I. Field

The following description relates generally to communications systems, and more particularly to scheduling and processing of data packets for high speed data networks.

II. Background

Wireless communication systems are widely deployed to provide various types of communication content such as voice, data, and so forth. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems including E-UTRA, and orthogonal frequency division multiple access (OFDMA) systems.

An orthogonal frequency division multiplex (OFDM) communication system effectively partitions the overall system bandwidth into multiple (N_{F}) subcarriers, which may also be referred to as frequency sub-channels, tones, or frequency bins. For an OFDM system, the data to be transmitted (i.e., the information bits) is first encoded with a particular coding scheme to generate coded bits, and the coded bits are further grouped into multi-bit symbols that are then mapped to modulation symbols. Each modulation symbol corresponds to a point in a signal constellation defined by a particular modulation scheme (e.g., M-PSK or M-QAM) used for data transmission. At each time interval that may be dependent on the bandwidth of each frequency subcarrier, a modulation symbol may be transmitted on each of the N_{F} frequency subcarrier. Thus, OFDM may be used to combat inter-symbol interference (ISI) caused by frequency selective fading, which is characterized by different amounts of attenuation across the system bandwidth.

Generally, a wireless multiple-access communication system can concurrently support communication for multiple wireless terminals that communicate with one or more base stations via transmissions on forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

A MIMO system employs multiple (NT) transmit antennas and multiple (NR) receive antennas for data transmission. A MIMO channel formed by the NT transmit and NR receive antennas may be decomposed into NS independent channels, which are also referred to as spatial channels. Generally, each of the NS independent channels corresponds to a dimension. The MIMO system can provide improved performance (e.g., higher throughput and/or greater reliability) if the additional dimensionalities created by the multiple transmit and receive antennas are utilized. A MIMO system also supports time division duplex (TDD) and frequency division duplex (FDD) systems. In a TDD system, the forward and reverse link transmissions are on the same frequency region so that the reciprocity principle allows estimation of the forward link channel from the reverse link channel. This enables an access point to extract transmit beam-forming gain on the forward link when multiple antennas are available at the access point.

Related to such communications includes generating and processing data packets on wireless networks that are sometimes referred to as high speed packet data networks. High speed data packets are generally processed by a scheduler that determines the priority for data packets and processes them according to their priority. These packets are often placed in multiple queues, where the packets can belong to different quality of service (QOS) flows. The scheduler ideally takes into account the time spent by each packet in the queue during each scheduling opportunity. This approach, however, has high complexity and thus results in higher processing costs.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its sole purpose is to present some concepts in a simplified form as a prelude to the more detailed description that is presented later.

Systems and methods are provided to determine burst size for a high speed packet data network having multiple queues. The burst size can be defined as an estimate of the number of packets that arrived in an interval of time (either specified statically or at run time), relative to time such as a head of the line (HOL) data packet arrived, for example. The burst size is employed by scheduling components that allow data to be processed across the networks in an orderly manner. In general, the system provides various processes and methods for determining the burst size in an efficient manner. This includes processing multiple packet queues for a high speed packet data networks and associating one or more arrays for the multiple packet queues. For example, one array can be generated for each queue. Other processes include generating an index for the arrays, where the index can be associated with a time stamp in order to determine a burst size for the high speed packet data network. The index can be associated with a bin number that is a quantized version of a system time stamp, where the arrays can include a number of data packets that have arrived in an interval corresponding to the index.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 is a high level block diagram of a system that determines burst size for high speed packet data networks in a wireless communications environment.

FIG. 2 is a diagram that illustrates an example burst size processor for a wireless system.

FIG. 3 is a block diagram of an example system for scheduling resources in a wireless communication system.

FIG. 4 illustrates an example system for analyzing packet bursts to be communicated in a wireless communication system.

FIG. 5 illustrates a wireless communications method for burst size processing.

FIG. 6 illustrates an example logical module for a burst size processor.

FIG. 7 illustrates an example logical module for an alternative burst size processor.

FIG. 8 illustrates an example communications apparatus that employs a wireless burst size processing.

FIG. 9 illustrates a multiple access wireless communication system.

FIGS. 10 and 11 illustrate example communications systems.

### DETAILED DESCRIPTION

Systems and methods are provided to determine burst size for high speed packet data networks, where the burst size is employed for scheduling data packets within the networks. In one aspect, a method for communications is provided. The method includes employing a processor executing computer executable instructions stored on a computer readable storage medium to implement various acts or processes. The method includes processing multiple packet queues for a high speed packet data network and associating one or more arrays for the multiple packet queues. The method also includes generating an index for the arrays, where the index is associated with a time stamp in order to determine a burst size for the high speed packet data network.

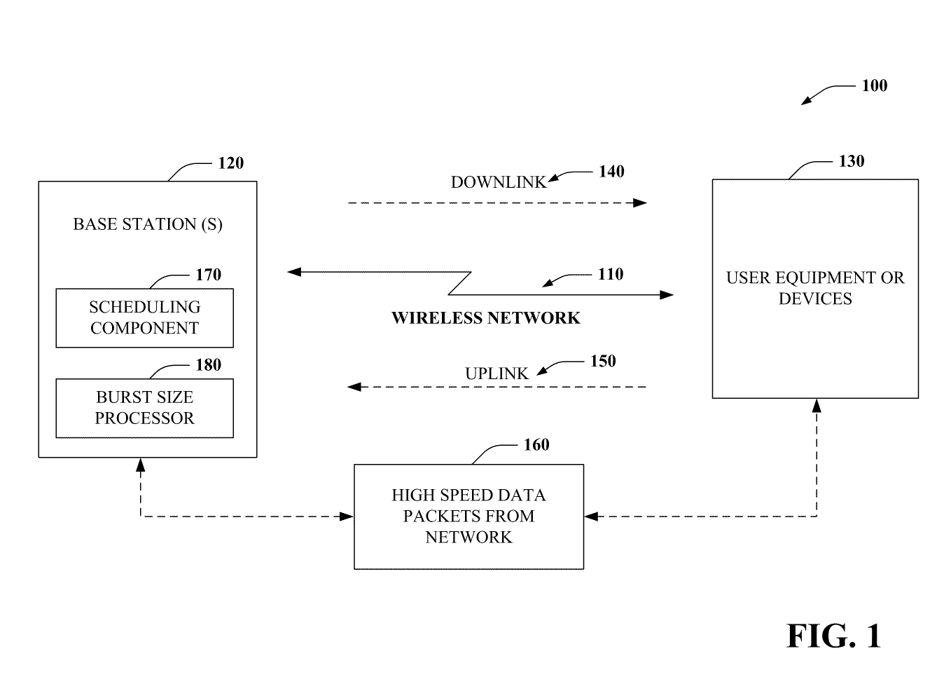

Referring now to FIG. 1, a system 100 determines burst size for high speed packet data networks for a wireless communications system. The system 100 includes one or more base stations 120 (also referred to as a node, evolved node B—eNB, femto station, pico station, and so forth) which can be an entity capable of communication over a wireless network 110 to a second device 130 (or devices). For instance, each device 130 can be an access terminal (also referred to as terminal, user equipment, mobility management entity (MME) or mobile device). The base station 120 communicates to the device 130 via downlink 140 and receives data via uplink 150. Such designation as uplink and downlink is arbitrary as the device 130 can also transmit data via downlink and receive data via uplink channels. It is noted that although two components 120 and 130 are shown, that more than two components can be employed on the network 110, where such additional components can also be adapted for the wireless protocols or data packet processing described herein. As shown, high speed data packets 160 are processed between the base station 120 and the terminal 130. It is also noted that the network 110 can include wired networks and/or wireless networks.

The high speed data packets 160 are processed via a scheduling component 170 and burst size processor 180, where the scheduling component is employed to prioritize and process data according to the time it is received on the network 100 (e.g., staler data given an ever-increasing sense of priority). The burst component 180 is employed to determine packet size estimates for data that is associated with multiple processing queues and is described in more detail below. Although only one scheduling component 170 and burst processor 180 is shown at the base 120, it is to be appreciated that other scheduling components and burst processors can be employed across the network 110. For instance, the user equipment could include a scheduling component 170 or a burst size processor 180, respectively to process the high speed data packets.

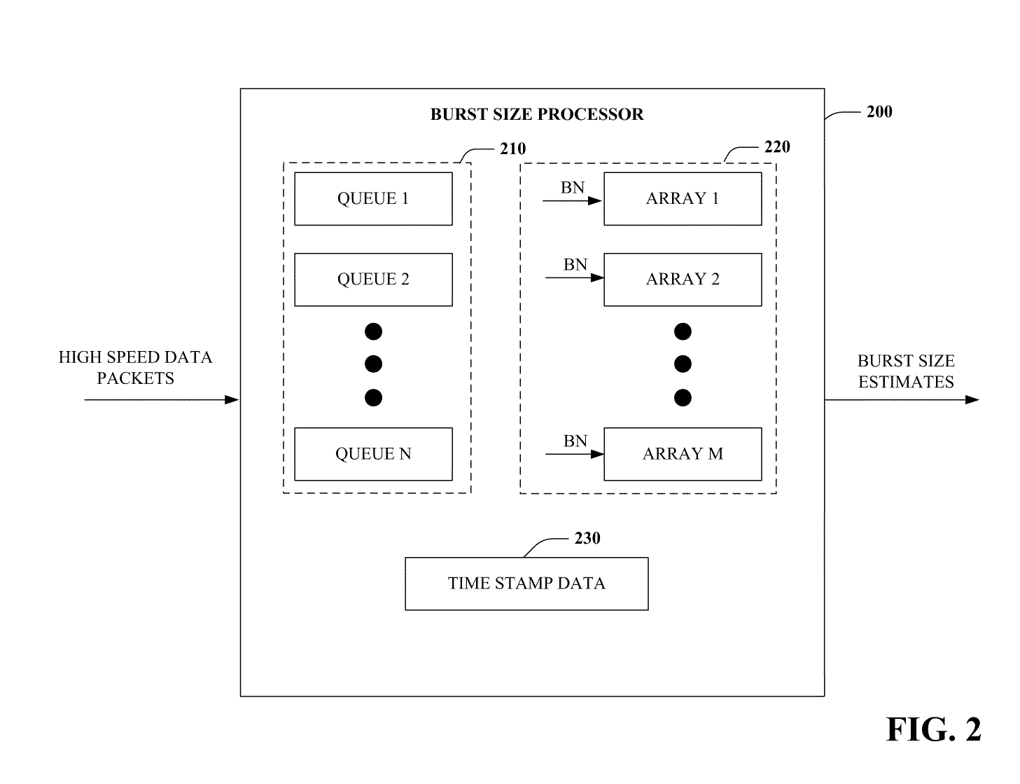

In one aspect, the burst size processor which is described in more detail below with respect to FIG. 2 is utilized to determine a burst size for high speed packet data networks having multiple processing queues. The burst size can be defined as an estimate of the number of packets 160 that arrived in an interval of time (either specified statically or at run time), relative to time such as a head of the line (HOL) data packet arrived, for example. The burst size can be employed by the scheduling component 170 to process data across the network 100 in an orderly manner. In general, the system 100 provides various processes and methods for determining the burst size in an efficient manner. This includes processing multiple packet queues for a high speed packet data networks and associating one or more arrays for the multiple packet queues. For example, one array can be generated for each queue (See FIG. 2). Other processes include generating an index for the arrays, where the index can be associated with a time stamp in order to determine a burst size for the high speed packet data packets 160. The index can be associated with a bin number that is a quantized version of a system time stamp, where the arrays can include a number of data packets that have arrived in an interval corresponding to the index.

Other processing aspects includes time-stamping each data packet by the burst size processor 180. This process can include adding a value of a system time to the data packet 160 as the packet is located in a queue, for example. The burst size process can also include incrementing a packet counter in view of a quantized system time, where the quantized system time is a quantized system arrival time for a data packet, where the packet counter can be decremented when a packet is processed from a queue. The burst size processor 180 also determines a Head of the Line (HOL) packet from a queue at a time t1, where t is an integer representing time. This process can include determining an interval including times t2 and t3, where t2 and t3 are relative to t1, for example. The burst processor 180 can also determine bin indices i2 and i3 that are quantized versions of system times t2+t1 and t3+t1, where i is an integer representing the indices. The burst processing also includes determining a burst size as a packet counter array element [i2]+packet counter array element [i2+1]+ . . . +packet counter array element [i3], and so forth. As noted previously, the burst size processor 180 will be illustrated and discussed in more detail with respect to FIG. 2.

It is noted that the system 100 can be employed with an access terminal or mobile device, and can be, for instance, a module such as an SD card, a network card, a wireless network card, a computer (including laptops, desktops, personal digital assistants (PDAs)), mobile phones, smart phones, or any other suitable terminal that can be utilized to access a network. The terminal accesses the network by way of an access component (not shown). In one example, a connection between the terminal and the access components may be wireless in nature, in which access components may be the base station and the mobile device is a wireless terminal. For instance, the terminal and base stations may communicate by way of any suitable wireless protocol, including but not limited to Time Divisional Multiple Access (TDMA), Code Division Multiple Access (CDMA), Frequency Division Multiple Access (FDMA), Orthogonal Frequency Division Multiplexing (OFDM), FLASH OFDM, Orthogonal Frequency Division Multiple Access (OFDMA), or any other suitable protocol.

Access components can be an access node associated with a wired network or a wireless network. To that end, access components can be, for instance, a router, a switch, or the like. The access component can include one or more interfaces, e.g., communication modules, for communicating with other network nodes. Additionally, the access component can be a base station (or wireless access point) in a cellular type network, wherein base stations (or wireless access points) are utilized to provide wireless coverage areas to a plurality of subscribers. Such base stations (or wireless access points) can be arranged to provide contiguous areas of coverage to one or more cellular phones and/or other wireless terminals.

Referring now to FIG. 2, a diagram 200 illustrates an example burst size processor 200 for a wireless system. As noted previously, the burst processor processes data packets across a high speed packet data networks, where the packets are placed in multiple queues as shown at 210 e.g., queue 1, queue 2, and queue N, where N is a positive integer. These packets can be associated with quality of service (QOS) flows with the quality of service depending on the time spent in the queue by the packets. A scheduler (described above) ideally takes into account the time spent by each packet in the queue during each scheduling opportunity. Having to process each packet in this manner can increase the complexity of the scheduler and the resultant processing however. An alternative is to use a burst size parameter, which can be defined as an estimate of the number of packets that arrived in an interval of time (either specified statically or at run time), relative to the time the head of the line (HOL) packet arrived.

Thus, various methods are provided within the burst processor 200 for determining the burst size for high speed packet data networks having multiple queues 210. For example, for substantially every queue, an array 220 is maintained, e.g., intervalPktCnt, that is indexed by a bin number. This bin number (shown as BN on FIG. 2) is a quantized version of the time stamp in the system, where a time stamp component 230 provides time stamp data. The array 220 includes the number of packets that arrived in the interval corresponding to the bin index. Each packet can be time stamped by adding the value of the system time that the packet was en-queued or located to the packet, where a value intervalPktCnt [qtzedSysTime] is incremented and further where qtzedSysTime is the quantized system arrival time for the packet.

When a packet is processed from the queue 210, decrement intervalPktCnt [qtzedSysTime] where qtzedSysTime is the quantized system arrival time for the packet. In order to compute the burst size when the queue's head of the line (HOL) packet had arrived at t1 for an interval [t2, t3], (note that t2 and t3 are relative to t1), the burst processor locates bin indices, i2 and i3, that are the bin indices (i.e., the quantized versions) for system times t2+t1, and t3+t1 respectively. The burst size is then returned as intervalPktCnt[i2]+intervalPktCnt[i2+1]+ . . . +intervalPktCnt[i3], and so forth. It is noted that at least one array 220 can be associated with each queue 210. However, other arrangements are also possible. For instance, a general queue containing sub-queues could be maintained that was further processed by fewer arrays than a one-to-one relationship between arrays and queues as shown in FIG. 2.

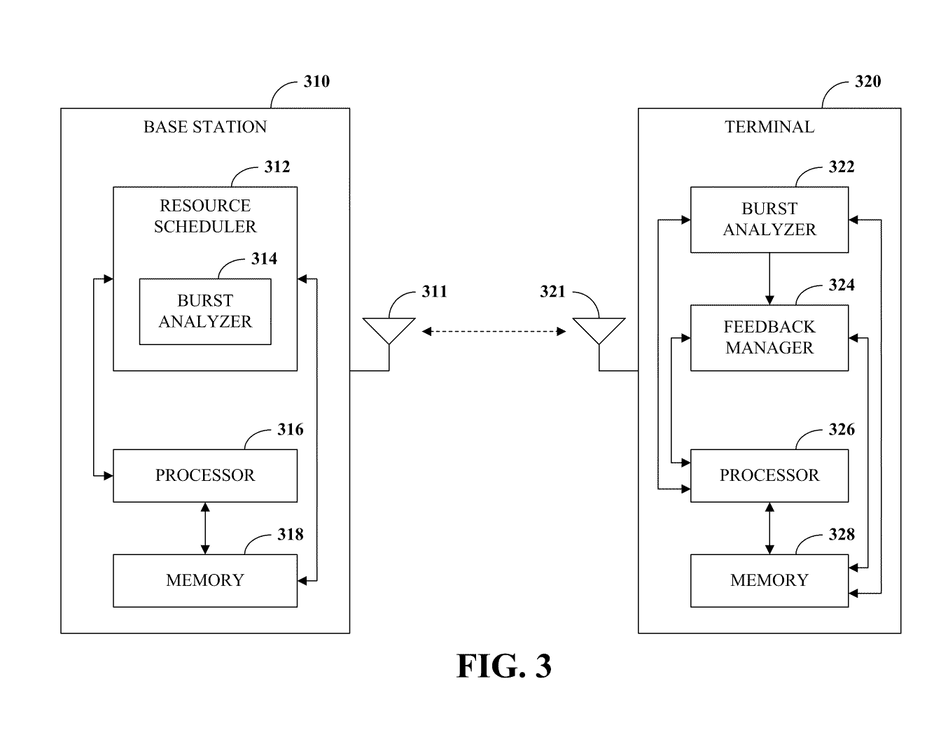

Turning to FIG. 3, as example system 300 is illustrated for scheduling resources in a wireless communication network. In accordance with one aspect, the system 300 can include one or more base stations 310 and one or more terminals 320, which can communicate with each other on the uplink and/or downlink via respective antennas 311 and/or 321. It can be appreciated that system 300 can include any number of base stations 310 and/or terminals 320, each of which can communicate with other entities in system 300 via any number of antennas 311 and/or 321.

In one example, a base station 310 and terminal 320 in system 300 can communicate pursuant to one or more resource assignments issued for said communication. For example, the base station 310 can utilize a resource scheduler 312 to schedule resources to be utilized by base station 310 and/or terminal 320 for communication based in whole or in part on feedback obtained from terminal 320 via a feedback manager 324 associated therewith. In one example, the feedback manager 324 can generate and/or facilitate communication of feedback relating to channel quality, transmit queue length, delay information, and/or other information as observed by terminal 320. It should be appreciated, however, that while resource scheduler 312 is illustrated at base station 310 and feedback manager 324 is illustrated at terminal 320, respective base stations 310 and/or terminals 320 in system 300 can have the functionality of either a resource scheduler 312 or a feedback manager 324.

In accordance with one aspect, a resource scheduler 312 can be utilized within system 300 to compute an allocation of resources such as power and/or bandwidth for one or more flows that utilize system 300 based on various factors. For example, resource scheduler 312 can allocate resources to various flows to ensure fairness between flows, to meet quality of service (QoS) constraints, to exploit multi-user diversity, and so on. In one example, flows for which resource scheduler 312 can schedule resources can include best effort or “elastic” flows, delay QoS-sensitive or “inelastic” flows, and the like. As used herein, a delay sensitive flow is a flow wherein each packet is associated with a strict deadline for scheduling, such that a packet is assumed to be useless after its deadline has passed. In one example, for scheduling resources for a delay sensitive flow, resource scheduler 312 can consider parameters such as channel quality, packet delay, and the like.

The base station 310 and/or terminal 320 in system 300 can include respective burst analyzers 314 and/or 322 in accordance with various aspects described herein. In one example, burst analyzers 314 and/or 322 can perform analysis for respective groups (or bursts) of packets that arrive within a predetermined time period of each other rather than for the individual packets themselves, thereby saving computational cost associated with analyzing individual packets. In addition, it can be appreciated that packets that arrive within a sufficiently small time window can have substantially similar deadlines and/or other properties. Accordingly, burst analyzers 314 and/or 322 can analyze a head or leading packet in a burst to determine a relative priority to apply to all packets in the burst.

In accordance with one aspect, the burst analyzer 314 at base station 310 can be utilized in cooperation with a resource scheduler 312 and/or individually to determine an optimal resource schedule for one or more flows that are utilized for communication in system 300. Base station 310 can additionally utilize a processor 316 and/or memory 318 to act as and/or to implement the functionality of resource scheduler 312 and/or burst analyzer 314.

In accordance with another aspect, the burst analyzer 322 at terminal 320 can be utilized in cooperation with a feedback manager 324 and/or individually to generate and communicate feedback regarding respective analyzed bursts to base station 310 and/or another appropriate network entity. Feedback provided by feedback manager 324 can include, for example, burst sizes, head-of-line delay parameters associated with respective packet bursts, and/or other suitable information. Terminal 320 can also utilize a processor 326 and/or memory 328 to act as and/or to implement the functionality of burst analyzer 322 and/or feedback manager 324.

In a further aspect, while not illustrated in system 300, base station 310 can utilize burst analyzer 314 to facilitate feedback to terminal 320 and/or another entity in system 300, and terminal 320 can utilize burst analyzer 322 to facilitate resource scheduling for terminal 320 and/or other entities in system 300.

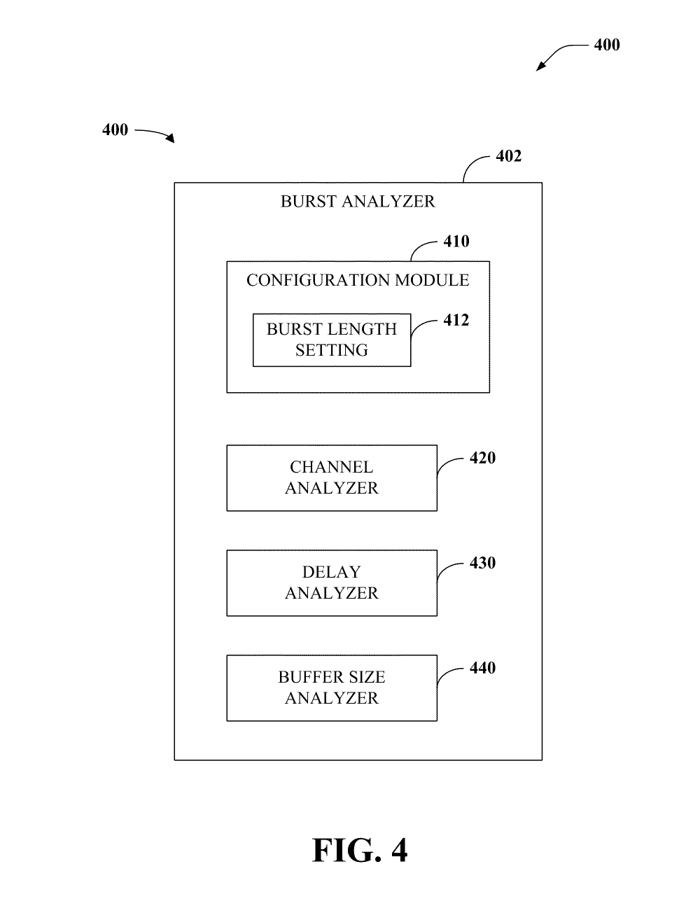

Referring to FIG. 4, an example system 400 is illustrated for analyzing packet bursts to be communicated in a wireless communication network. The system 400 can include a burst analyzer 402, which can be utilized by one or more entities in a wireless communication system (e.g., base station and/or terminal) to facilitate scheduling communication resources for respective packet bursts. In one example, burst analyzer 402 can include a configuration module 410 for controlling operation of the burst analyzer 402, as well as a channel analyzer 420, a delay analyzer 430, and/or a buffer size analyzer 440 for analyzing various aspects of respective packet bursts.

In accordance with one aspect, configuration module 410 can be utilized to adjust a burst length setting 412 for burst analyzer 402, which represents a predefined amount of time and/or number of sub-frames for which received packets are grouped into packet bursts. In one example, a burst length setting 412 can be selected for use by burst analyzer 402 to facilitate a tradeoff between information and complexity. For example, a long burst length (e.g., 25 ms) facilitates a reduction in complexity at the cost of information, and a short burst length (e.g., 5 ms) facilitates gathering more information at the cost of complexity.

In accordance with another aspect, based on settings provided by configuration module 410, burst analyzer 402 can determine information relating to respective observed packet bursts. For example, burst analyzer 402 can observe one or more flows to obtain information relating to sizes of respective bursts on the observed flow(s). In one example, burst size can be determined as a number of bytes for a given flow i that arrive within a burst length in time and/or sub-frames (e.g., as provided by burst length setting 412) from a head-of-line packet and that have been cached.

In another example, channel analyzer 420 can be utilized to obtain channel quality information (CQI) relating to one or more sub-bands on which a device associated with burst analyzer 402 communicates. In an example where system resources are provided in terms of frequency, the total frequency band utilized by a system can be denoted as divided into M sub-bands j, handled respectively by resource blocks (RBs). Accordingly, assuming a uniform distribution of power, channel analyzer 420 can compute spectral efficiency (e.g., in bits per symbol) corresponding to the modulation and coding scheme (MCS) that is achievable for a flow i at time t in sub-band j for a Hybrid Automatic Repeat Request (H-ARQ) termination target H. By way of specific example, H-ARQ termination target H can vary from 0 to 5. In one example, respective flows can be configured with corresponding pre-fixed termination targets (e.g., depending on their QoS types). Accordingly, the dependency on termination target H can be suppressed by channel analyzer 420. In one example, spectral efficiency can be determined as a function of CQI reported on a given sub-band and a transmission mode utilized to communicate data by a device associated with burst analyzer 402.

In a third example, delay analyzer 430 can be utilized to obtain head-of-line delay information corresponding to one or more flows for which communication is conducted by a device associated with burst analyzer 402. By way of specific example, head-of-line delay can be computed by delay analyzer 430 as the time expired since a head-of-line packet in a flow was received by the Media Access Control (MAC) layer.

In a fourth example, buffer size analyzer 440 can be utilized to obtain buffer size information relating to one or more flows for which communication is conducted by a network entity associated with burst analyzer 402. Buffer size can be determined by buffer size analyzer 440 as, for example, the sum of the number of bytes that are cached for a given flow and the estimated overheads (e.g., headers) for transmitting the cached bytes.

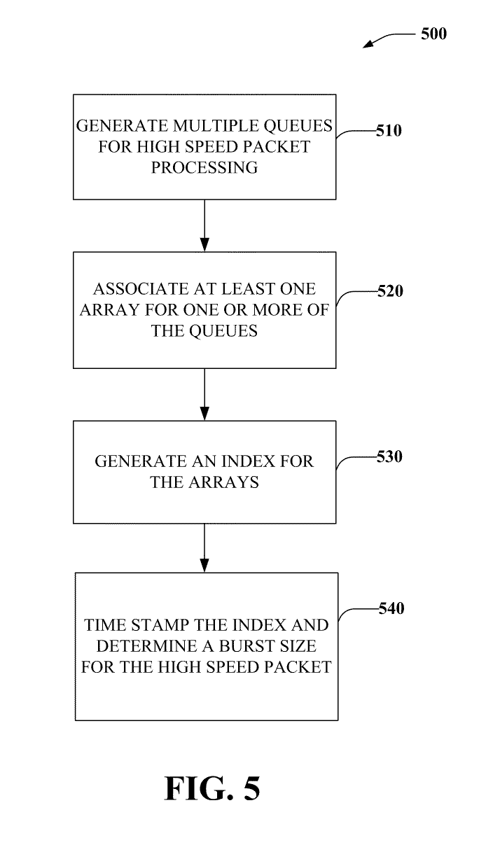

Referring now to FIG. 5, a wireless communications methodology 500 is illustrated. While, for purposes of simplicity of explanation, the methodology (and other methodologies described herein) are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be utilized to implement a methodology in accordance with the claimed subject matter.

Proceeding to 510, multiple packet queues are generated for high speed packet data processing. At 520, one or more arrays are associated with the multiple packet queues. For example, one array can be generated for each queue as previously described but it is to be appreciated other arrangements are possible e.g., general queues or arrays having sub-queues or sub-arrays. Other processes include generating an index for the arrays at 530, where the index can be associated with a time stamp at 540 in order to determine a burst size for the high speed packet received at 510. The index can be associated with a bin number that is a quantized version of a system time stamp, where the arrays can include a number of data packets that have arrived in an interval corresponding to the index.

As noted previously, other processing aspects includes time-stamping each data packet. This process can include adding a value of a system time to the data packet as the packet is located in a queue, for example. The burst size process can also include incrementing a packet counter in view of a quantized system time, where the quantized system time is a quantized system arrival time for a data packet, where the packet counter can be decremented when a packet is processed from a queue. The process also determines a Head of the Line (HOL) packet from a queue at a time t1, where t is an integer representing time. This process can include determining an interval including times t2 and t3, where t2 and t3 are relative to t1, for example. The process can also determine bin indices i2 and i3 that are quantized versions of system times t2+t1 and t3+t1, where i is an integer representing the indices. The processing also includes determining a burst size as a packet counter array element [i2]+packet counter array element [i2+1]+ . . . +packet counter array element [i3], and so forth.

The techniques described herein may be implemented by various means. For example, these techniques may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. With software, implementation can be through modules (e.g., procedures, functions, and so on) that perform the functions described herein. The software codes may be stored in memory unit and executed by the processors.

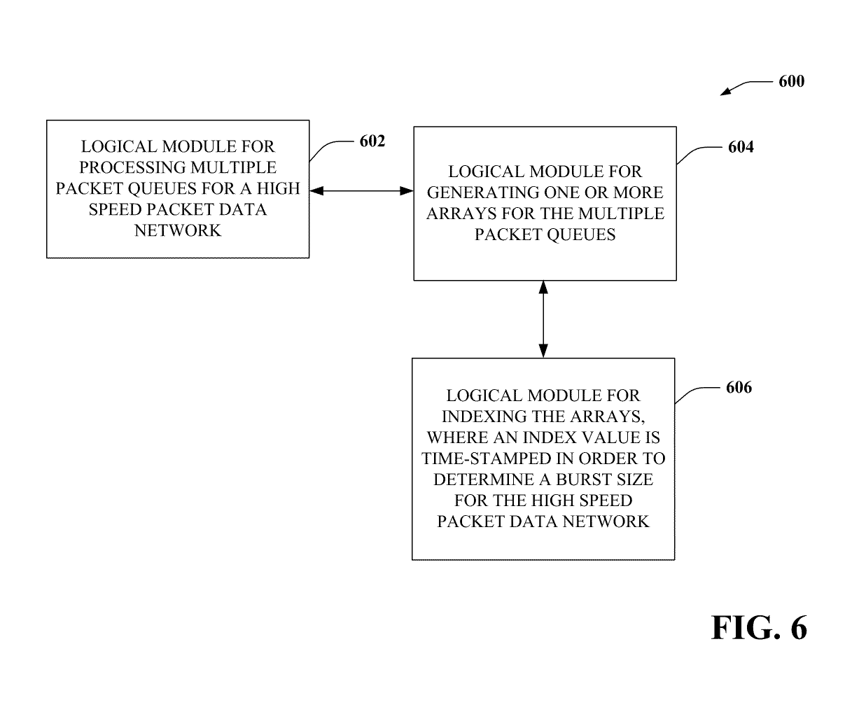

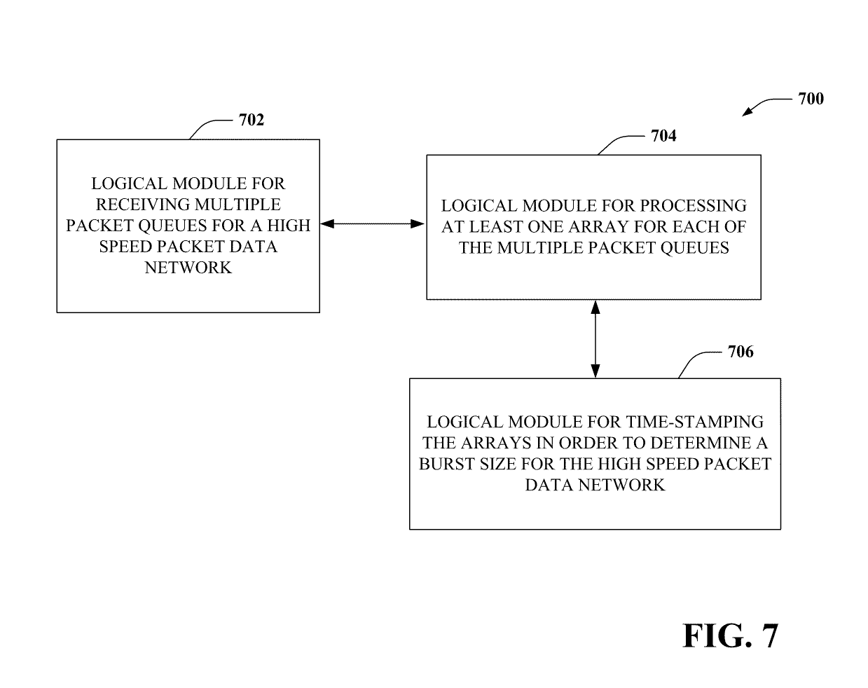

Turning now to FIGS. 6 and 7, a system is provided that relates to wireless signal processing. The systems are represented as a series of interrelated functional blocks, which can represent functions implemented by a processor, software, hardware, firmware, or any suitable combination thereof.

Referring to FIG. 6, a wireless communication system 600 is provided. The system 600 includes a logical module 602 or means for processing multiple packet queues for a high speed packet data network and a logical module 604 or means for generating one or more arrays for the multiple packet queues. The system 600 also includes a logical module 606 or means for indexing the arrays, where an index value is time-stamped in order to determine a burst size for the high speed packet data network.

Referring to FIG. 7, a wireless communication system 700 is provided. The system 700 includes a logical module 702 or means for receiving multiple packet queues for a high speed packet data network and a logical module 704 or means for processing at least one array for each of the multiple packet queues. The system 700 also includes a logical module 706 or means for time-stamping the arrays in order to determine a burst size for the high speed packet data network.

In another aspect, a communications method includes: processing multiple packet queues for a high speed packet data network; associating one or more arrays for the multiple packet queues; and generating an index for the arrays, where the index is associated with a time stamp in order to determine a burst size for the high speed packet data network. The index is associated with a bin number that is a quantized version of a system time stamp and the arrays include a number of data packets that have arrived in an interval corresponding to the index. The method includes time-stamping each data packet and adding a value of a system time to the data packet as the packet is located in a queue. This includes incrementing a packet counter in view of a quantized system time, where the quantized system time is a quantized system arrival time for a data packet. The method includes decrementing the packet counter when a packet is processed from a queue and determining a Head of the Line (HOL) packet from a queue at a time t1, where t is an integer representing time. This includes determining an interval including times t2 and t3, where t2 and t3 are relative to t1. The method includes determining bin indices i2 and i3 that are quantized versions of system times t2+t1 and t3+t1, where i is an integer representing the indices. This also includes determining a burst size as a packet counter array element [i2]+packet counter array element [i2+1]+ . . . +packet counter array element [i3]. This can also include processing of a time-stamped index, for example.

In another aspect, a communications apparatus is provided that includes a memory that retains instructions for generating multiple packet queues for a high speed packet data network, generating multiple arrays for the multiple packet queues, and generating an index for the arrays, where the index is associated with a time stamp in order to determine a burst size for the high speed packet data network. This includes a processor that executes the instructions.

In another aspect, a computer program product includes a computer-readable medium that includes code for data packet processing, where the code includes: code for causing a computer to generate multiple packet queues for a high speed packet data network; code for causing a computer to generate multiple arrays for the multiple packet queues; and code for causing a computer to time-stamp the arrays in order to determine a burst size for the high speed packet data network. This includes code for causing a computer to generate a bin number that is a quantized version of a system time stamp.

In another aspect, a processor is provided that executes the following instructions: processing multiple packet queues for a high speed packet data network; generating multiple arrays for the multiple packet queues, where at least one array is associated with at least one packet queue; and time-stamping the arrays in order to determine a burst size for the high speed packet data network.

In another aspect, a communications method, includes: receiving multiple packet queues for a high speed packet data network; generating one or more arrays for the multiple packet queues and associating at least one queue with each of the generated arrays; and processing an index that is associated with a time stamp in order to determine a burst size for the high speed packet data network.

In yet another aspect, a communications apparatus, includes: a memory that retains instructions for processing multiple packet queues for a high speed packet data network, processing multiple arrays for the multiple packet queues; associating at least one queue with each array that is processed, and processing an index for the arrays, where the index is associated with a time stamp in order to determine a burst size for the high speed packet data network. This includes a processor that executes the instructions.

In another aspect, a computer program product, includes: code for causing a computer to receive multiple packet queues for a high speed packet data network; code for causing a computer process multiple arrays for the multiple packet queues and associating at least one array with each of the queues received from the multiple packet queues; and code for causing a computer to time-stamp the arrays in order to determine a burst size for the high speed packet data network. This also includes code for causing a computer to generate a bin number that is a quantized version of a system time stamp.

In another aspect, a processor is provided that executes the following instructions: receiving multiple packet queues for a high speed packet data network; processing multiple arrays for the multiple packet queues, where each array from the multiple arrays is associated with at least one packet queue from the multiple packet queues; and time-stamping the arrays in order to determine a burst size for the high speed packet data network.

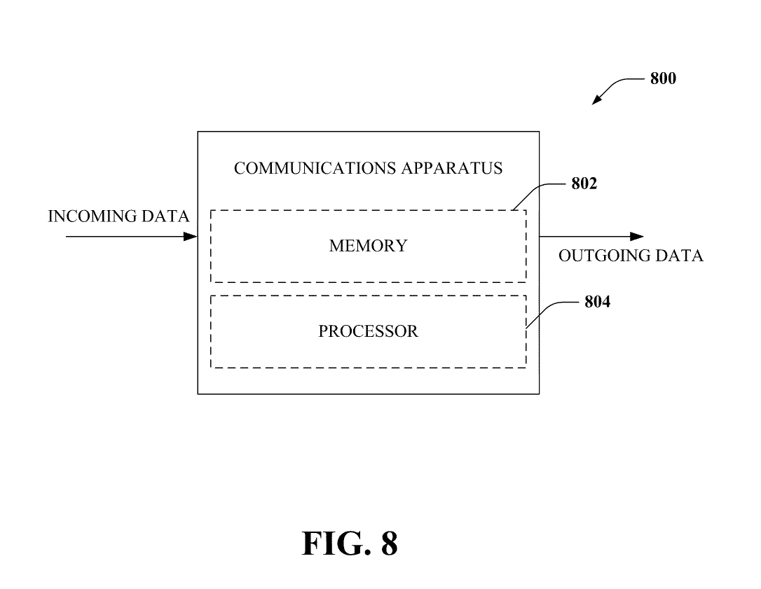

FIG. 8 illustrates a communications apparatus 800 that can be a wireless communications apparatus, for instance, such as a wireless terminal. Additionally or alternatively, communications apparatus 800 can be resident within a wired network. Communications apparatus 800 can include memory 802 that can retain instructions for performing a signal analysis in a wireless communications terminal. Additionally, communications apparatus 800 may include a processor 804 that can execute instructions within memory 802 and/or instructions received from another network device, wherein the instructions can relate to configuring or operating the communications apparatus 800 or a related communications apparatus.

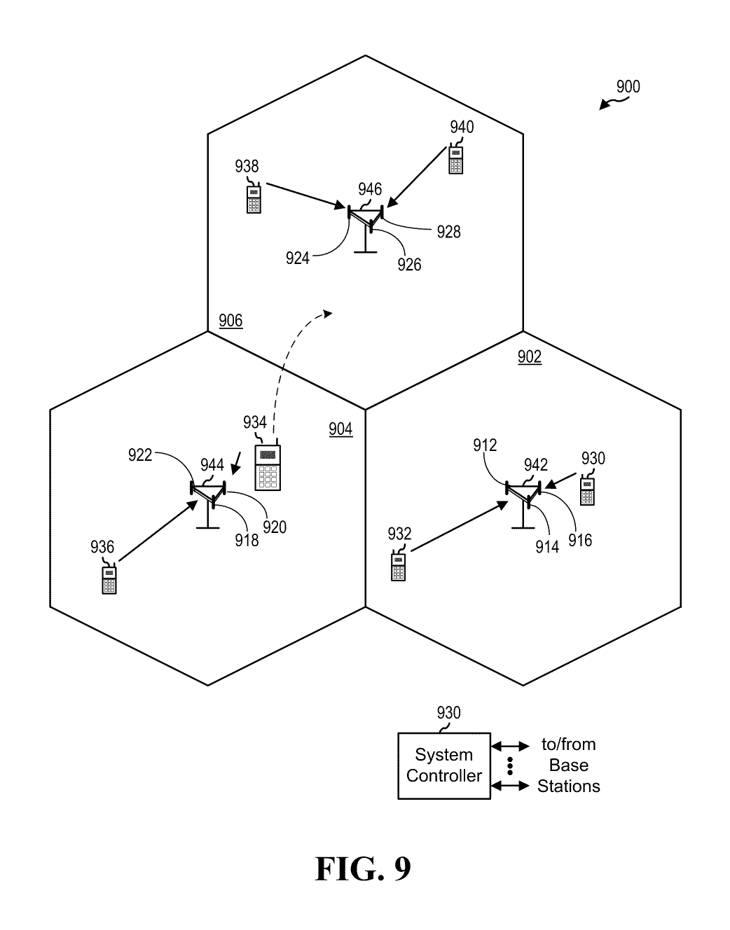

Referring to FIG. 9, a multiple access wireless communication system 900 is illustrated. The multiple access wireless communication system 900 includes multiple cells, including cells 902, 904, and 906. In the aspect the system 900, the cells 902, 904, and 906 may include a Node B that includes multiple sectors. The multiple sectors can be formed by groups of antennas with each antenna responsible for communication with UEs in a portion of the cell. For example, in cell 902, antenna groups 912, 914, and 916 may each correspond to a different sector. In cell 904, antenna groups 918, 920, and 922 each correspond to a different sector. In cell 906, antenna groups 924, 926, and 928 each correspond to a different sector. The cells 902, 904 and 906 can include several wireless communication devices, e.g., User Equipment or UEs, which can be in communication with one or more sectors of each cell 902, 904 or 906. For example, UEs 930 and 932 can be in communication with Node B 942, UEs 934 and 936 can be in communication with Node B 944, and UEs 938 and 940 can be in communication with Node B 946.

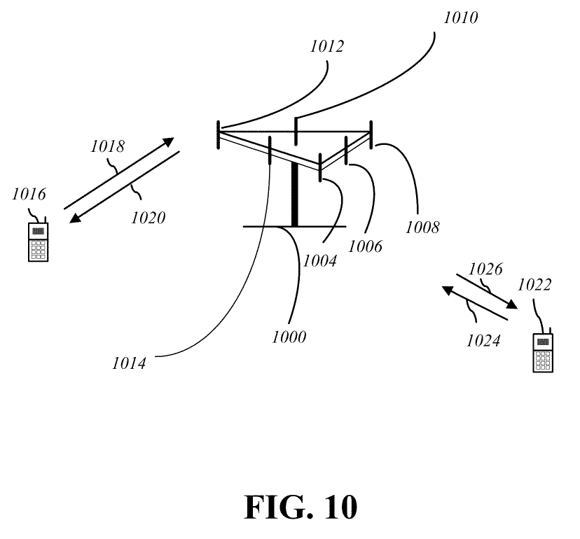

Referring now to FIG. 10, a multiple access wireless communication system according to one aspect is illustrated. An access point 1000 (AP) includes multiple antenna groups, one including 1004 and 1006, another including 1008 and 1010, and an additional including 1012 and 1014. In FIG. 10, only two antennas are shown for each antenna group, however, more or fewer antennas may be utilized for each antenna group. Access terminal 1016 (AT) is in communication with antennas 1012 and 1014, where antennas 1012 and 1014 transmit information to access terminal 1016 over forward link 1020 and receive information from access terminal 1016 over reverse link 1018. Access terminal 1022 is in communication with antennas 1006 and 1008, where antennas 1006 and 1008 transmit information to access terminal 1022 over forward link 1026 and receive information from access terminal 1022 over reverse link 1024. In a FDD system, communication links 1018, 1020, 1024 and 1026 may use different frequency for communication. For example, forward link 1020 may use a different frequency then that used by reverse link 1018.

Each group of antennas and/or the area in which they are designed to communicate is often referred to as a sector of the access point. Antenna groups each are designed to communicate to access terminals in a sector, of the areas covered by access point 1000. In communication over forward links 1020 and 1026, the transmitting antennas of access point 1000 utilize beam-forming in order to improve the signal-to-noise ratio of forward links for the different access terminals 1016 and 1024. Also, an access point using beam-forming to transmit to access terminals scattered randomly through its coverage causes less interference to access terminals in neighboring cells than an access point transmitting through a single antenna to all its access terminals. An access point may be a fixed station used for communicating with the terminals and may also be referred to as an access point, a Node B, or some other terminology. An access terminal may also be called an access terminal, user equipment (UE), a wireless communication device, terminal, access terminal or some other terminology.

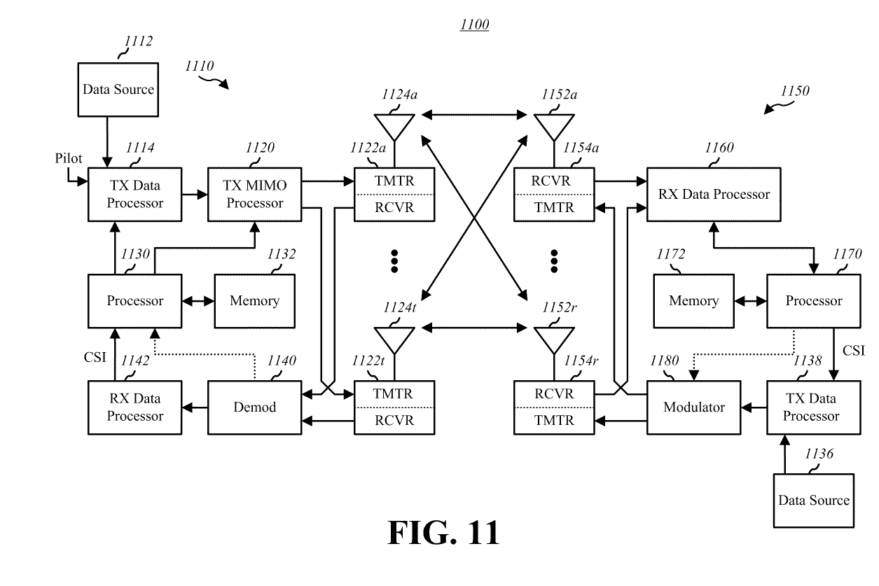

Referring to FIG. 11, a system 1100 illustrates a transmitter system 210 (also known as the access point) and a receiver system 1150 (also known as access terminal) in a MIMO system 1100. At the transmitter system 1110, traffic data for a number of data streams is provided from a data source 1112 to a transmit (TX) data processor 1114. Each data stream is transmitted over a respective transmit antenna. TX data processor 1114 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 1130.

The modulation symbols for all data streams are then provided to a TX MIMO processor 1120, which may further process the modulation symbols (e.g., for OFDM). TX MIMO processor 1120 then provides NT modulation symbol streams to NT transmitters (TMTR) 1122a through 1122t. In certain embodiments, TX MIMO processor 1120 applies beam-forming weights to the symbols of the data streams and to the antenna from which the symbol is being transmitted.

Each transmitter 1122 receives and processes a respective symbol stream to provide one or more analog signals, and further conditions (e.g., amplifies, filters, and up-converts) the analog signals to provide a modulated signal suitable for transmission over the MIMO channel. NT modulated signals from transmitters 1122a through 1122t are then transmitted from NT antennas 1124a through 1124t, respectively.

At receiver system 1150, the transmitted modulated signals are received by NR antennas 1152a through 1152r and the received signal from each antenna 1152 is provided to a respective receiver (RCVR) 1154a through 1154r. Each receiver 1154 conditions (e.g., filters, amplifies, and down-converts) a respective received signal, digitizes the conditioned signal to provide samples, and further processes the samples to provide a corresponding “received” symbol stream.

An RX data processor 1160 then receives and processes the NR received symbol streams from NR receivers 1154 based on a particular receiver processing technique to provide NT “detected” symbol streams. The RX data processor 1160 then demodulates, de-interleaves, and decodes each detected symbol stream to recover the traffic data for the data stream. The processing by RX data processor 1160 is complementary to that performed by TX MIMO processor 1120 and TX data processor 1114 at transmitter system 1110.

A processor 1170 periodically determines which pre-coding matrix to use (discussed below). Processor 1170 formulates a reverse link message comprising a matrix index portion and a rank value portion. The reverse link message may comprise various types of information regarding the communication link and/or the received data stream. The reverse link message is then processed by a TX data processor 1138, which also receives traffic data for a number of data streams from a data source 1136, modulated by a modulator 1180, conditioned by transmitters 1154a through 1154r, and transmitted back to transmitter system 1110.

At transmitter system 1110, the modulated signals from receiver system 1150 are received by antennas 1124, conditioned by receivers 1122, demodulated by a demodulator 1140, and processed by a RX data processor 1142 to extract the reserve link message transmitted by the receiver system 1150. Processor 1130 then determines which pre-coding matrix to use for determining the beam-forming weights then processes the extracted message.

In an aspect, logical channels are classified into Control Channels and Traffic Channels. Logical Control Channels comprises Broadcast Control Channel (BCCH) which is DL channel for broadcasting system control information. Paging Control Channel (PCCH) which is DL channel that transfers paging information. Multicast Control Channel (MCCH) which is Point-to-multipoint DL channel used for transmitting Multimedia Broadcast and Multicast Service (MBMS) scheduling and control information for one or several MTCHs. Generally, after establishing RRC connection this channel is only used by UEs that receive MBMS (Note: old MCCH+MSCH). Dedicated Control Channel (DCCH) is Point-to-point bi-directional channel that transmits dedicated control information and used by UEs having an RRC connection. Logical Traffic Channels comprise a Dedicated Traffic Channel (DTCH) which is Point-to-point bi-directional channel, dedicated to one UE, for the transfer of user information. Also, a Multicast Traffic Channel (MTCH) for Point-to-multipoint DL channel for transmitting traffic data.

Transport Channels are classified into DL and UL. DL Transport Channels comprises a Broadcast Channel (BCH), Downlink Shared Data Channel (DL-SDCH) and a Paging Channel (PCH), the PCH for support of UE power saving (DRX cycle is indicated by the network to the UE), broadcasted over entire cell and mapped to PHY resources which can be used for other control/traffic channels. The UL Transport Channels comprises a Random Access Channel (RACH), a Request Channel (REQCH), an Uplink Shared Data Channel (UL-SDCH) and plurality of PHY channels. The PHY channels comprise a set of DL channels and UL channels.

The DL PHY channels comprises: Common Pilot Channel (CPICH), Synchronization Channel (SCH), Common Control Channel (CCCH), Shared DL Control Channel (SDCCH), Multicast Control Channel (MCCH), Shared UL Assignment Channel (SUACH), Acknowledgement Channel (ACKCH), DL Physical Shared Data Channel (DL-PSDCH), UL Power Control Channel (UPCCH), Paging Indicator Channel (PICH), and Load Indicator Channel (LICH), for example.

The UL PHY Channels comprises: Physical Random Access Channel (PRACH), Channel Quality Indicator Channel (CQICH), Acknowledgement Channel (ACKCH), Antenna Subset Indicator Channel (ASICH), Shared Request Channel (SREQCH), UL Physical Shared Data Channel (UL-PSDCH), and Broadband Pilot Channel (BPICH), for example.

Other terms/components include: 3G 3rd Generation, 3GPP 3rd Generation Partnership Project, ACLR Adjacent channel leakage ratio, ACPR Adjacent channel power ratio, ACS Adjacent channel selectivity, ADS Advanced Design System, AMC Adaptive modulation and coding, A-MPR Additional maximum power reduction, ARQ Automatic repeat request, BCCH Broadcast control channel, BTS Base transceiver station, CDD Cyclic delay diversity, CCDF Complementary cumulative distribution function, CDMA Code division multiple access, CFI Control format indicator, Co-MIMO Cooperative MIMO, CP Cyclic prefix, CPICH Common pilot channel, CPRI Common public radio interface, CQI Channel quality indicator, CRC Cyclic redundancy check, DCI Downlink control indicator, DFT Discrete Fourier transform, DFT-SOFDM Discrete Fourier transform spread OFDM, DL Downlink (base station to subscriber transmission), DL-SCH Downlink shared channel, D-PHY 500 Mbps physical layer, DSP Digital signal processing, DT Development toolset, DVSA Digital vector signal analysis, EDA Electronic design automation, E-DCH Enhanced dedicated channel, E-UTRAN Evolved UMTS terrestrial radio access network, eMBMS Evolved multimedia broadcast multicast service, eNB Evolved Node B, EPC Evolved packet core, EPRE Energy per resource element, ETSI European Telecommunications Standards Institute, E-UTRA Evolved UTRA, E-UTRAN Evolved UTRAN, EVM Error vector magnitude, and FDD Frequency division duplex.

Still yet other terms include FFT Fast Fourier transform, FRC Fixed reference channel, FS1 Frame structure type 1, FS2 Frame structure type 2, GSM Global system for mobile communication, HARQ Hybrid automatic repeat request, HDL Hardware description language, HI HARQ indicator, HSDPA High speed downlink packet access, HSPA High speed packet access, HSUPA High speed uplink packet access, IFFT Inverse FFT, IOT Interoperability test, IP Internet protocol, LO Local oscillator, LTE Long term evolution, MAC Medium access control, MBMS Multimedia broadcast multicast service, MBSFN Multicast/broadcast over single-frequency network, MCH Multicast channel, MIMO Multiple input multiple output, MISO Multiple input single output, MME Mobility management entity, MOP Maximum output power, MPR Maximum power reduction, MU-MIMO Multiple user MIMO, NAS Non-access stratum, OBSAI Open base station architecture interface, OFDM Orthogonal frequency division multiplexing, OFDMA Orthogonal frequency division multiple access, PAPR Peak-to-average power ratio, PAR Peak-to-average ratio, PBCH Physical broadcast channel, P-CCPCH Primary common control physical channel, PCFICH Physical control format indicator channel, PCH Paging channel, PDCCH Physical downlink control channel, PDCP Packet data convergence protocol, PDSCH Physical downlink shared channel, PHICH Physical hybrid ARQ indicator channel, PHY Physical layer, PRACH Physical random access channel, PMCH Physical multicast channel, PMI Pre-coding matrix indicator, P-SCH Primary synchronization signal, PUCCH Physical uplink control channel, and PUSCH Physical uplink shared channel.

Other terms include QAM Quadrature amplitude modulation, QPSK Quadrature phase shift keying, RACH Random access channel, RAT Radio access technology, RB Resource block, RF Radio frequency, RFDE RF design environment, RLC Radio link control, RMC Reference measurement channel, RNC Radio network controller, RRC Radio resource control, RRM Radio resource management, RS Reference signal, RSCP Received signal code power, RSRP Reference signal received power, RSRQ Reference signal received quality, RSSI Received signal strength indicator, SAE System architecture evolution, SAP Service access point, SC-FDMA Single carrier frequency division multiple access, SFBC Space-frequency block coding, S-GW Serving gateway, SIMO Single input multiple output, SISO Single input single output, SNR Signal-to-noise ratio, SRS Sounding reference signal, S-SCH Secondary synchronization signal, SU-MIMO Single user MIMO, TDD Time division duplex, TDMA Time division multiple access, TR Technical report, TrCH Transport channel, TS Technical specification, TTA Telecommunications Technology Association, TTI Transmission time interval, UCI Uplink control indicator, UE User equipment, UL Uplink (subscriber to base station transmission), UL-SCH Uplink shared channel, UMB Ultra-mobile broadband, UMTS Universal mobile telecommunications system, UTRA Universal terrestrial radio access, UTRAN Universal terrestrial radio access network, VSA Vector signal analyzer, W-CDMA Wideband code division multiple access

It is noted that various aspects are described herein in connection with a terminal. A terminal can also be referred to as a system, a user device, a subscriber unit, subscriber station, mobile station, mobile device, remote station, remote terminal, access terminal, user terminal, user agent, or user equipment. A user device can be a cellular telephone, a cordless telephone, a Session Initiation Protocol (SIP) phone, a wireless local loop (WLL) station, a PDA, a handheld device having wireless connection capability, a module within a terminal, a card that can be attached to or integrated within a host device (e.g., a PCMCIA card) or other processing device connected to a wireless modem.

Moreover, aspects of the claimed subject matter may be implemented as a method, apparatus, or article of manufacture using standard programming and/or engineering techniques to produce software, firmware, hardware, or any combination thereof to control a computer or computing components to implement various aspects of the claimed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving voice mail or in accessing a network such as a cellular network. Of course, those skilled in the art will recognize many modifications may be made to this configuration without departing from the scope or spirit of what is described herein.

As used in this application, the terms “component,” “module,” “system,” “protocol,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A communications method, comprising:
processing multiple packet queues for a high speed packet data network;
associating one or more arrays for the multiple packet queues; and
generating an index for the arrays, where the index is associated with a time stamp in order to determine a burst size for the high speed packet data network.

2. The method of claim 1, the index is associated with a bin number that is a quantized version of a system time stamp.

3. The method of claim 1, the arrays include a number of data packets that have arrived in an interval corresponding to the index.

4. The method of claim 3, further comprising time-stamping each of the data packets.

5. The method of claim 4, further comprising adding a value of a system time to the data packets as a data packet is located in a queue.

6. The method of claim 5, further comprising incrementing a packet counter in view of a quantized system time.

7. The method of claim 6, the quantized system time is a quantized system arrival time for a data packet.

8. The method of claim 7, further comprising decrementing the packet counter when a packet is processed from a queue.

9. The method of claim 8, further comprising determining a Head of the Line (HOL) packet from a queue at a time t1, where t is an integer representing time.

10. The method of claim 9, further comprising determining an interval including times t2 and t3, where t2 and t3 are relative to t1.

11. The method of claim 10, further comprising determining bin indices i2 and i3 that are quantized versions of system times t2+t1 and t3+t1, where i is an integer representing the indices.

12. The method of claim 11, further comprising determining a burst size as a packet counter array element [i2]+packet counter array element [i2+1]+ . . . +packet counter array element [i3].

13. A communications apparatus, comprising:
a memory that retains instructions for generating multiple packet queues for a high speed packet data network, generating multiple arrays for the multiple packet queues; and generating an index for the arrays, where the index is associated with a time stamp in order to determine a burst size for the high speed packet data network; and
a processor that executes the instructions.

14. The communications apparatus of claim 13, the index is associated with a bin number that is a quantized version of the system time stamp.

15. The communications apparatus of claim 13, the arrays include data packets that have arrived in an interval corresponding to the index.

16. The communications apparatus of claim 15, further comprising time-stamping the data packets and adding a value of a system time to the data packets as the data packets are located in a queue.

17. The communications apparatus of claim 16, further comprising determining a Head of the Line (HOL) packet from a queue at a time t1, where t is an integer representing time.

18. The communications apparatus of claim 17, further comprising determining an interval including times t2 and t3, where t2 and t3 are relative to t1.

19. The communications apparatus of claim 18, further comprising determining bin indices i2 and i3 that are quantized versions of system times t2+t1 or t3+t1, where i is an integer representing the indices.

20. A communications apparatus, comprising:
means for processing multiple packet queues for a high speed packet data network;
means for generating one or more arrays for the multiple packet queues; and
means for indexing the arrays, where an index value is time-stamped in order to determine a burst size for the high speed packet data network.

21. The communications apparatus of claim 20, the index is associated with a bin number that is a quantized version of a system time stamp.

22. A computer program product, comprising:
a computer-readable medium that includes code for data packet processing, the code comprising:
code for causing a computer to generate multiple packet queues for a high speed packet data network;
code for causing a computer to generate multiple arrays for the multiple packet queues; and
code for causing a computer to time-stamp the multiple arrays in order to determine a burst size for the high speed packet data network.

23. The computer program product of claim 22, further comprising code for causing a computer to generate a bin number that is a quantized version of a system time stamp.

24. A processor that executes the following instructions:
processing multiple packet queues for a high speed packet data network;
generating multiple arrays for the multiple packet queues, where at least one array is associated with at least one packet queue; and
time-stamping the arrays in order to determine a burst size for the high speed packet data network.

25. The processor of claim 24, further comprising generating a time-stamped index for the arrays.

26. A communications method, comprising:
receiving multiple packet queues for a high speed packet data network;
generating one or more arrays for the multiple packet queues and associating at least one queue with each of the arrays; and
processing an index that is associated with a time stamp in order to determine a burst size for the high speed packet data network.

27. The method of claim 26, the index is associated with a bin number that is a quantized version of a system time stamp.

28. The method of claim 26, the arrays include a number of data packets that have arrived in an interval corresponding to the index.

29. The method of claim 28, further comprising time-stamping each of the data packets.

30. The method of claim 29, further comprising determining a Head of the Line (HOL) packet from a queue at a time t1, where t is an integer representing time.

31. The method of claim 30, further comprising determining an interval including times t2 and t3, where t2 and t3 are relative to t1.

32. The method of claim 31, further comprising determining bin indices i2 and i3 that are quantized versions of system times t2+t1 and t3+t1, where i is an integer representing the indices.

33. The method of claim 32, further comprising determining a burst size as a packet counter array element [i2]+packet counter array element [i2+1]+ . . . +packet counter array element [i3].

34. A communications apparatus, comprising:
a memory that retains instructions for processing multiple packet queues for a high speed packet data network, processing multiple arrays for the multiple packet queues; associating at least one queue with each array that is processed, and processing an index for the arrays, where the index is associated with a time stamp in order to determine a burst size for the high speed packet data network; and
a processor that executes the instructions.

35. The communications apparatus of claim 34, further comprising instructions for time-stamping data packets and adding a value of a system time to the data packets as the data packets are located in a queue.

36. A communications apparatus, comprising:
means for receiving multiple packet queues for a high speed packet data network;
means for processing at least one array for each of the multiple packet queues; and
means for time-stamping the arrays in order to determine a burst size for the high speed packet data network.

37. The communications apparatus of claim 36, further comprising an index that is associated with a bin number that is a quantized version of a system time stamp.

38. A computer program product, comprising:
a computer-readable medium that includes code to process data packets, the code comprising:
code for causing a computer to receive multiple packet queues for a high speed packet data network;
code for causing a computer to process multiple arrays for the multiple packet queues and associating at least one array with each of the queues received from the multiple packet queues; and
code for causing a computer to time-stamp the arrays in order to determine a burst size for the high speed packet data network.

39. The computer program product of claim 38, further comprising code for causing a computer to generate a bin number that is a quantized version of a system time stamp.

40. A processor that executes the following instructions:
receiving multiple packet queues for a high speed packet data network;
processing multiple arrays for the multiple packet queues, where each array from the multiple arrays is associated with at least one packet queue from the multiple packet queues; and
time-stamping the multiple arrays in order to determine a burst size for the high speed packet data network.

41. The processor of claim 40, further comprising generating a time-stamped index for the arrays.
